(19) United States
(12) Patent Application Publication
(10) Pub. No.: US 2007/0220851 A1
(43) Pub. Date: Sep. 27, 2007

(54) Modular air purification system

(76) Inventors: Nick Charles Parker, Lubbock, TX (US); Robert D. Rogers, Lubbock, TX (US)

Correspondence Address: Dr. Nick C. Parker, 7805 Zoar Ave, Lubbock, TX, 79424, US

(21) Appl. No.: 11/359,935

(22) Filed: Feb. 23, 2006

(51) Int. Cl. B01D 46/00

(52) U.S. Cl. 55/484

(57) ABSTRACT

A new and improved invention for the purification of quantity of air within an plenum, prior to introduction to an existing HVAC system, consisting of modular air purification units arrayed as to form a wall that may be permeated only through said modules. Each module of the invention is individually serviceable and may be partially removed from the overall system for replacement or maintenance.

### BACKGROUND

This invention related to industrial air purification, and specifically to commercial applications in which large volumes of air must be regularly monitored and purified. Although there are many existing systems available to purify the air, most systems rely on air passing through existing HVAC ducting. There are some instances, where a large amount of air must be purified prior to introduction into an HVAC system. In many existing air purification systems, ultraviolet light is used to kill airborne organisms. The problem that exists is that these systems are expensive and are required to be constructed into a structure.

Insofar as we are aware, there is not an air purification system or device that is modular in nature that can be adaptable to an existing structure.

### SUMMARY

The invention, an improved and modular air purification system is constructed of several modular units that may be stacked upwardly and laterally as to create a wall of air purification units. These units, being powered electronically are capable of eliminating airborne contaminants from passing air. The invention is designed to also facilitate both field service and field technology upgrades. The airflow, controlled by external means may be fixed or adjustable by the operator and will not affect the operation of the invention. Furthermore, the invention will allow a portion of the modular system to be easily removed as to allow an operator access to the space behind the invention.

Accordingly, several aspects of the invention have been designed to promote safe and easy operation of the invention.

### DETAILED DESCRIPTION

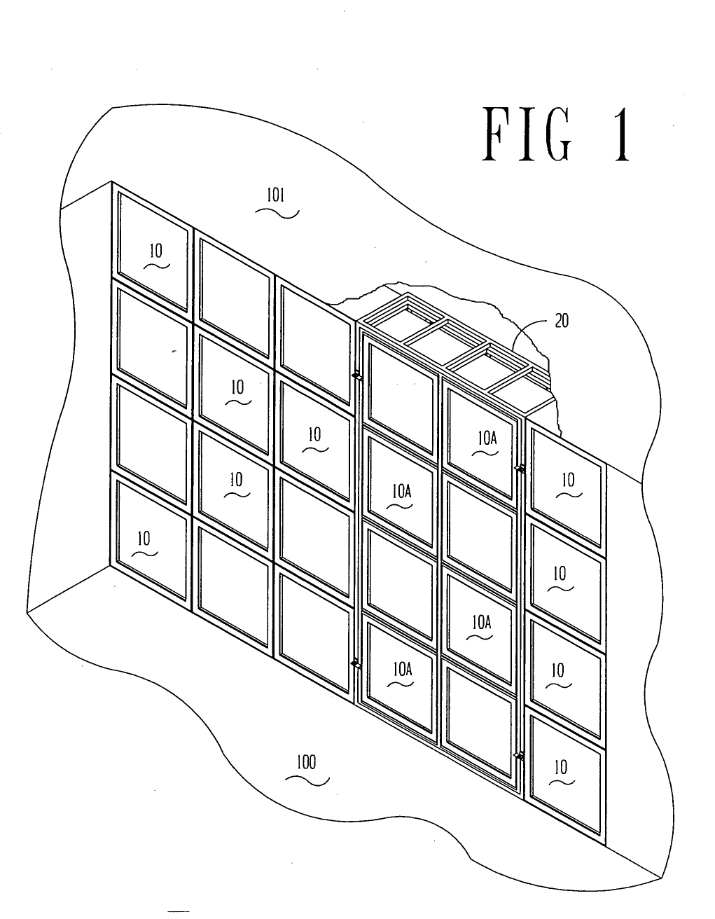

FIG. 1 is a perspective view of the invention with portions of an existing structure removed to show the proper arrangement of the modular air purifiers as to form a wall. Each modular unit 10 is shown stacked upwardly and laterally against one another as to form a wall. Also shown in the FIG is an internal structure of the invention 20 which holds additional air purification modules 30 that are slightly smaller in construction.

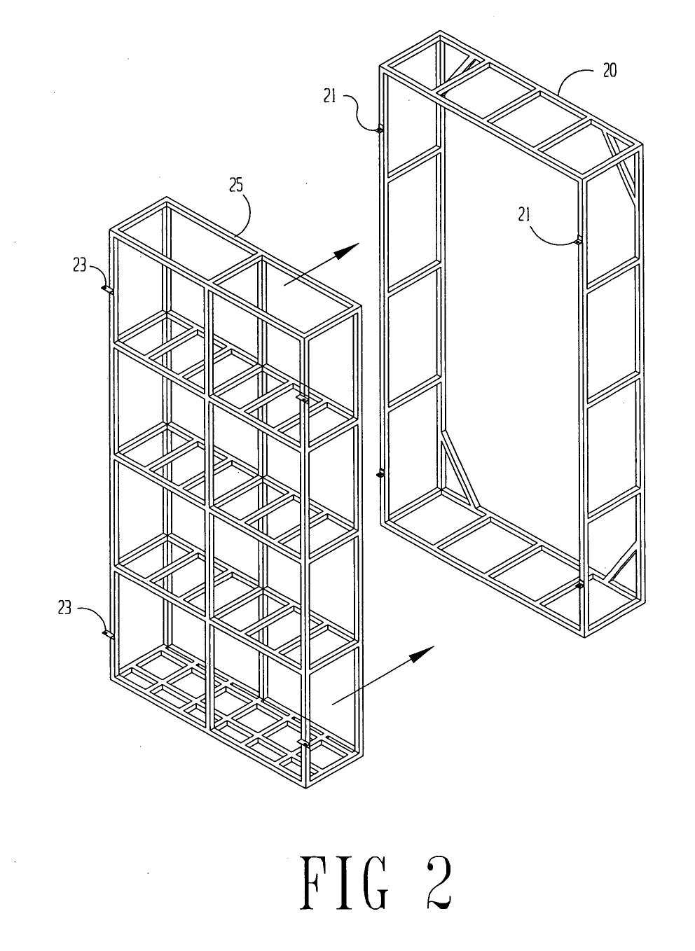

FIG. 2 is a perspective view of the internal structures of the invention that illustrates the primary structure 20 in relation to an internal and interlocking structure 25.

FIG. 3 is a side elevation with portions removed in order to illustrate the modular air purifiers 10 in relation to an existing structure. The FIG also illustrates proper airflow through the modular units 10 from an unpurified environment 105 to a purified air environment 110.

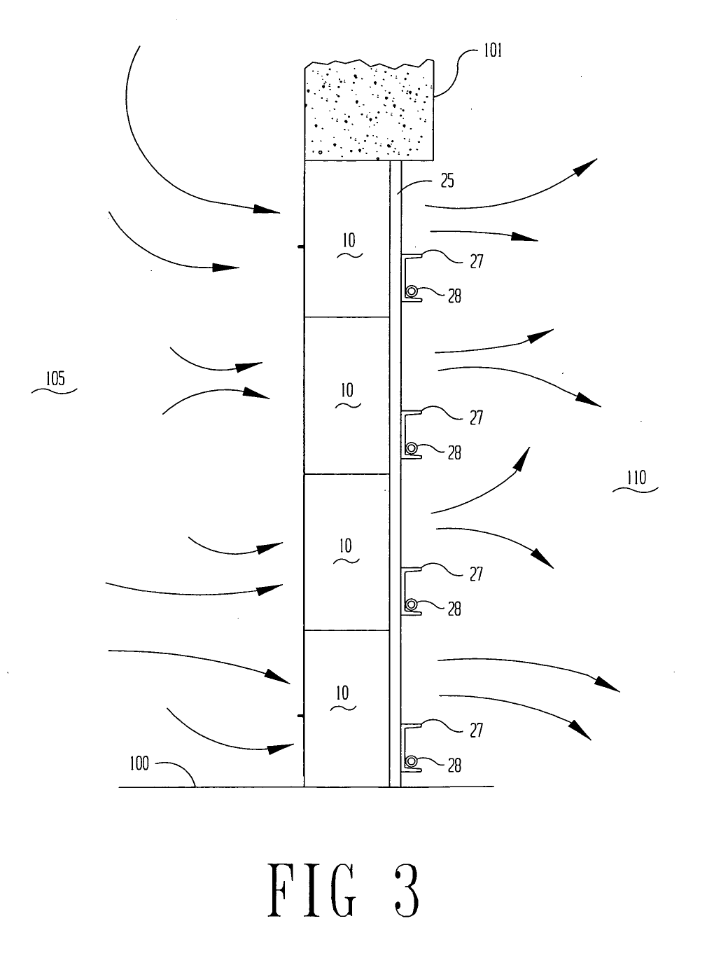

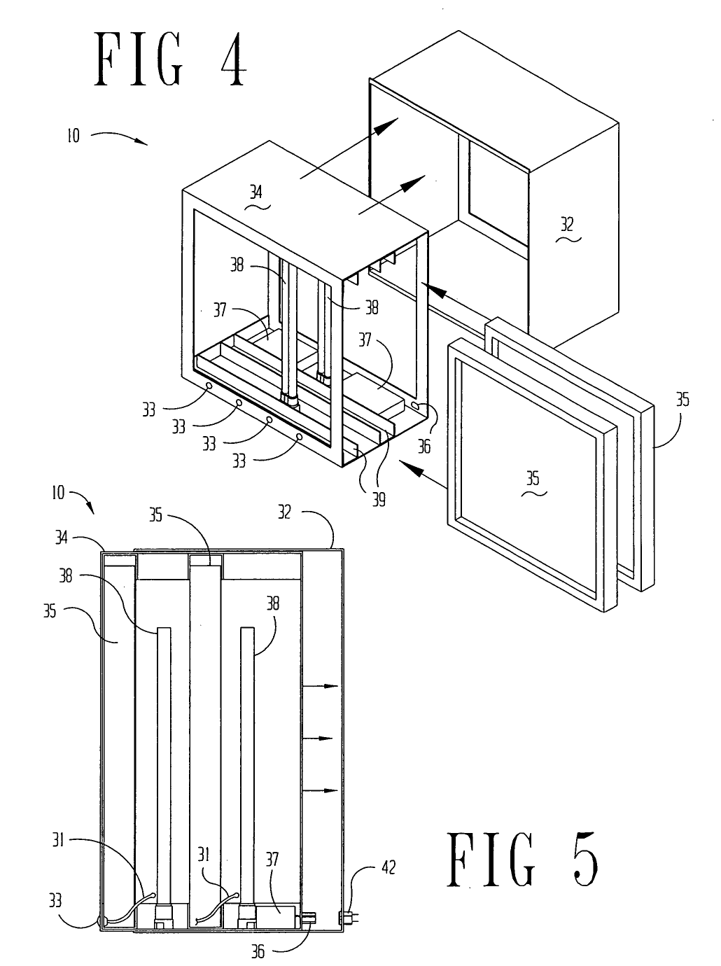

FIG. 4 is an exploded perspective view of an individual air purification module 10 in order to show its components: an external housing 32, an internal housing 34, air filters 35, ballasts 37, and ultraviolet germicidal irradiation (UVGI) lamps 38.

FIG. 5 is a side elevation of an individual air purification module 10 in sections to illustrate the proper mating of internal 35 and external 32 housings. The FIG further illustrated the electrical connection between housings, comprised of a male 36 and female 42 electrical connectors.

FIG. 6 is a side elevation of a working UVGI lamp 38 and an air filter 35 that illustrates the surface area purified by the air purification module.

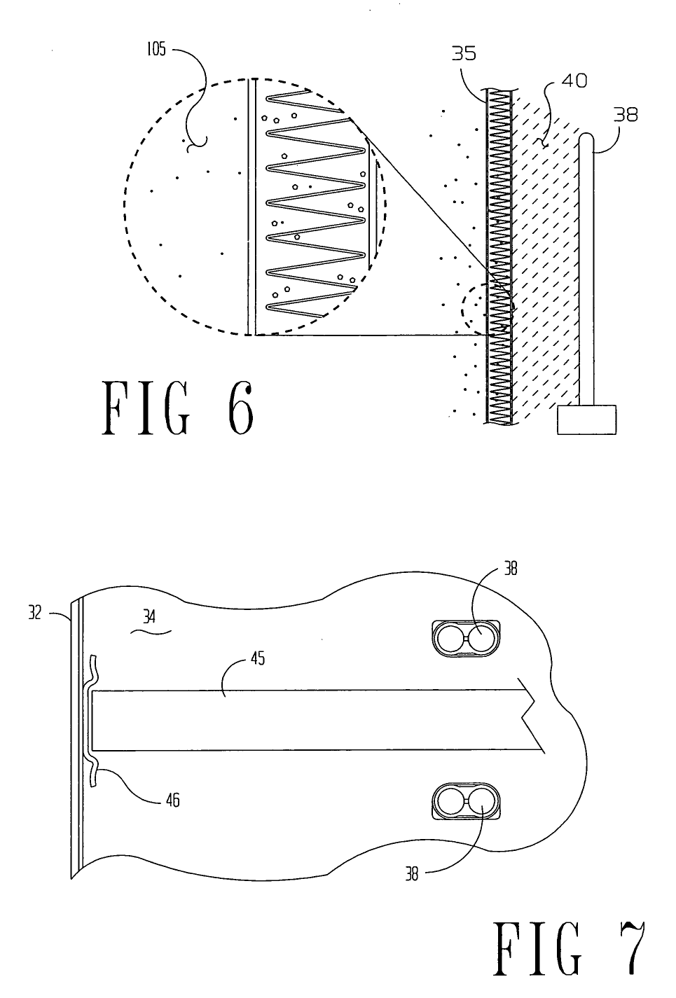

FIG. 7 is a top view of the invention with sections removed, which illustrates a possible alternative method of containing an air filter 45 within the inner housing 34. Through the use of a mechanical slip 46, an air filter 45 may be set in place within the invention.

FIG. 8 is a side elevation of the invention with sections removed that illustrates a possible secondary embodiment of the invention. The illustration indicates the proper removal of an air filter 45 and a UVGI lamp 38 from within the housing 34.

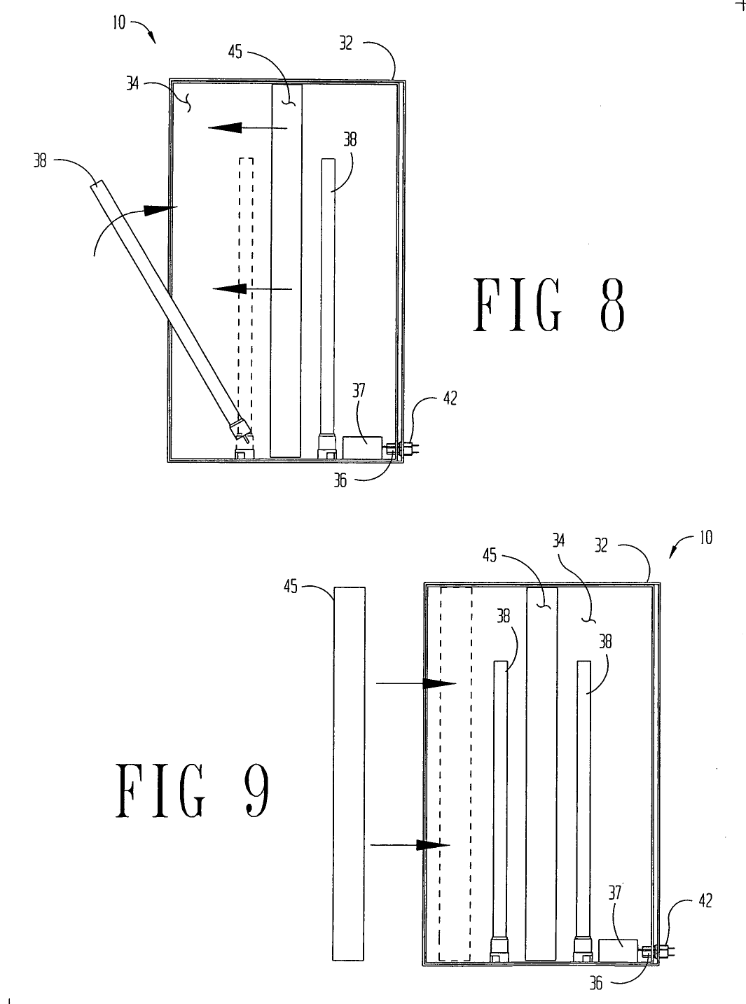

FIG. 9 is similarly a side elevation with sections removed that further illustrates a possible secondary embodiment of the invention, in which both UVGI lamps 38 and air filters 45 may be removed or introduced to the invention 10 through the front face of the housing 34.

### OPERATION

In operation, one uses this modular air purification system to construct a wall of modular air purifiers 30, each being modular in design as to fit alongside each other individual air purification modules 10. Each module 30 is designed as to fit alongside its corresponding units as to produce an airtight seal with one another.

The invention also uses an internal structure 20, which serves as a housing for a removable internal structure 25 that is designed to house individual modular units 30 which are constructed as to allow an airtight fit within said internal housing 25. Each structure contains means to lock itself to its corresponding structure 21 and 23.

In proper operation the invention will provide a wall of air purification modules 10 that will only allow air from an outer, non purified, environment 105 to enter a purified environment 110 by passing through said modules 10. The modules are designed as to create a seal with a floor 100 and existing walls and ceiling 101. The modular wall is reinforced by a series of vertical braces 25, which are aligned with each vertical row of the wall and extend from the floor 100 to the ceiling 101. A series of horizontally aligned cross members 27 are likewise located correspondingly to each horizontal row of modules 10. Each horizontal cross member 27 contains appropriate conduit 28 as to allow power to be drawn into each module 10.

Each air purification module 10 is comprised of an external housing 32, an internal housing 34, and air filtration means 35. The external housing 32 is fitted with a female electrical connector 42, designed to supply power to the internal housing 34 upon proper mating of the two housing sections. The internal housing also contains a plurality of internal ballasts 37, filter guides 39, ultraviolet germicidal irradiation (UVGI) lamps 38, light indicators 33, and fiber optic cabling 31.

When activated, the invention will allow an operator to purify a quantity of air from a room through external air movement means, through the air plenum. As power is supplied to the modular units 10, the UVGI lamps 38 will fire and emit an ultraviolet wavelength 40 that is capable of destroying organic airborne contaminants. A plurality of photoreactive air filtration media 35 will react with said wavelength 40 as to assist in the purification method.

The invention will provide adequate purification for a quantity of air passing through the invention so long as the power is on and all said modules are active and running. In the event that a repair or change of media 35 is necessary, the internal housing section 34 must be physically pulled away from the outer housing section 32 as to break the electrical connection between the male and female electrical connectors 37 and 42. When said electrical connection is disengaged, each modular unit 10 will shut off as to prevent accidental exposure by the operator to harmful UVGI radiation. Proper operation will be visually confirmed through the use of light indicators 33 which are connected to fiber optic cabling 31 and will indicate if its corresponding UVGI amp 38 is functioning properly.

In addition to the preferred embodiment mentioned, an alternative embodiment, illustrated in FIGS. 7-9, is allowable through which the invention, generally indicated at 10, may be serviced or inspected through the front face of the housing 34 as shown in FIGS. 8 and 9. In such an embodiment, air filters 45 are held in place through a mechanical means, such as a clip 46 as is illustrated in FIG. 7. Such mechanical means would allow the air filters 45 to be easily introduced and removed from the inner housing 34 of said invention 10, as illustrated in FIG. 9. In a similar fashion, the UVGI bulbs 38 could be removed in a similar fashion as illustrated in FIG. 8.

1. A modular air purification system comprising:
an exterior housing that is stackable upwardly and laterally, and
that is capable of holding within an internal housing,
that, when stacked creates an airtight seal with corresponding modular housings as to prevent air from passing between said modules,
that contains an internal housing containing within means for purifying external air that is introduced into said internal housing,
containing means for the introduction of electrical power to said internal housing upon proper mating of said external and said internal housings,
containing means for the immediate removal of power from the modular array of air purifiers upon the disengagement of a pair of said internal and external housings.

2. A corresponding structure that is suitable for containing an internal structure designed as to house a plurality of modular air purification units in a manner as to prevent air from passing between said structures and modular air units.
